(19) United States
(12) Patent Application Publication
(10) Pub. No.: US 2010/0261150 A1
(43) Pub. Date: Oct. 14, 2010

(54) Methods and Systems For Assessing and Monitoring Student Progress In an Online Secondary Education Environment

(75) Inventor: Michael Matwick, Tempe, AZ (US)

Correspondence Address: Morgan Law Offices, PLC, 4635 S. Lakeshore Dr. Suite 131, Tempe, AZ, 85282, US

(73) Assignee: PINNACLE EDUCATION, INC., Tempe, AZ (US)

(21) Appl. No.: 12/558,447

(22) Filed: Sep. 11, 2009

Related U.S. Application Data
(60) Provisional application No. 61/168,161, filed on Apr. 9, 2009.

(51) Int. Cl. G09B 3/00

(52) U.S. Cl. 434/350

(57) ABSTRACT

A set of rules are applied to information relating to student activity in online courses, to form a set of progress indicators. Each morning, dashboards are generated for instructors showing the set of progress indicators, so that the instructors have the latest pertinent information to ensure students are progressing properly. By proactively focusing on the progress indicators, instructors are able to ensure student success.

### CROSS REFERENCE TO RELATED APPLICATIONS

This application claims the benefit of U.S. Provisional Application Ser. No. 61/168,161, filed by Michael Matwick on Apr. 9, 2009 and entitled “Virtual Secondary Education Systems”, which is incorporated herein by reference.

### FIELD OF THE INVENTION

This invention relates to improved virtual secondary education systems. More particularly, it relates to methods and systems for assessing and monitoring student progress in an online secondary education environment.

### BACKGROUND OF THE INVENTION

Traditionally, high school takes place in a highly structured environment in which students are placed into courses that must be completed according to a rigid time schedule and at a particular pace. Failure to complete the requisite courses according to plan can result in student failure. Moreover, even when students comply with the requirements, the process can be frustrating and wasteful. As many commentators have noted, the traditional “bricks and mortar” approach to secondary education is out of date and fails to consider recent advances in technology.

Unfortunately, even most online secondary education suffers from many of the same problems. One of the main difficulties is that the maturity and individual needs of students are not taken into consideration. Unlike adult learners, teens are not always motivated to learn, can be easily distracted, and may have special emotional and cognitive problems that inhibit progress. On the other side of the spectrum, conventional online secondary education also does a poor job dealing with gifted students, who may be ahead of the class and wish to explore subjects in greater depth.

Several patents disclose aspects of online secondary education. For example, U.S. Pat. No. 7,210,938 to Packard et al. describes an Internet-based elementary and secondary school. However, there have been few attempts to systematically manage student progress in online secondary education. U.S. Pat. No. 6,704,541 Ciarallo et al. discloses a method and system for tracking the progress of students in an online course, but this reference is limited to tracking course activities.

Accordingly, there is a need for improved techniques for assessing and monitoring student progress in an online secondary education environment. In particular it would be highly desirable for student progress in an online secondary education course to be assessed frequently and instructors provided with key indicators of the student progress on a regular and timely basis.

### SUMMARY OF THE INVENTION

In accordance with a preferred embodiment of the present invention, a method for assessing student progress in an online secondary education environment is provided. The method comprises the steps of obtaining, by a computer process, a result set from a database management system with information relating to student activity in an online secondary education course; using the obtained result set and a set of predetermined rules to form, by the computer process, a set of progress indicators that reflect current student progress in the online secondary education course; and generating, by the computer process, at least one dashboard showing the set of progress indicators.

Preferably, the set of progress indicators includes progress indicators relating to Engagement, Time, Pace, and Grade. Preferably, the Engagement progress indicator relates to a measure of log-ins relative to a predetermined measure, the Time progress indicator relates to a measure of an amount of time put into a course relative to a predetermined measure, the Pace progress indicator relates to a measure of an amount of course material covered within a specified period relative to a predetermined measure, and the Grade progress indicator relates to a measure of a course grade.

Preferably, each progress indicator in the set of progress indicators is a scored numerical value. For example, under the applied rules, a score of “1” could indicate an 80-100% compliance with a pertinent requirement, a score of “2” a 60-79% compliance with the requirement, and a score of “4” less than 60% compliance. Preferably, at least one of the dashboards will include a list of “underperforming students”. Preferably, the list of underperforming students includes an escalation level for each of the students on the list. Preferably, the escalation level increases when a problem is not resolved within a certain length of time (e.g., one week).

Preferably, the computer process implementing the method is a computer process that is scheduled to run after a predetermined cut-off time. Preferably, the dashboards can be made available each morning to instructors and administrators. Preferably, at least one of the generated dashboards is provided via a screen to an instructor, Alternatively, or in addition, the dashboards can be provided as hyperlinks (e.g., as a hyperlink included in an email note). A primary objective of the present invention is to arm instructors with information each morning regarding progress of each student.

Preferably, interactions with each student are recorded. Thus, when an instructor calls or emails the student or the student calls or emails an instructor, the date and time of the interaction and text describing the conversation is stored. Such interaction history information can be indexed, and thereby sorted, for example, in chronological order. It can be made accessible from a data warehouse (central repository) to anyone in the organization needing this information (e.g., via a screen or report). Such an arrangement allows a “call center” model in which any qualified individual can take a call from a student even if he or she is not the assigned instructor, using the interaction information obtained from the data warehouse, for guidance.

According to a preferred embodiment of the present invention, a computer-readable medium which stores a set of instructions which when executed performs a method for assessing student progress in an online secondary education environment comprises: obtaining, by a computer process, a result set from a database management system with information relating to student activity in an online secondary education course; using the obtained result set and a set of predetermined inference rules to form, by the computer process, a set of progress indicators that reflect current student progress in the online secondary education course; and generating, by the computer process, at least one dashboard showing the set of progress indicators.

According to a preferred embodiment of the present invention, the present invention is implemented as system comprising a Student Information System (SIS), a Learning Management System (LMS), a Data Warehouse that stores data from the SIS and the LMS, and a system for assessing student progress, including: an engine that obtains, by a computer process, a result set from the Data Warehouse with information relating to student activity in an online secondary education course, and uses the obtained result set and a set of predetermined rules, to form, by the computer process, a set of progress indicators that reflect current student progress in the online secondary education course; and an output device capable of outputting at least one dashboard showing the set of progress indicators.

In accordance with a preferred embodiment of the present invention, the present invention is implemented as a method comprising the steps of maintaining packet-forwarding information for communicating by a network protocol between a first data store and a second data store, the first data store including course information; transferring the course information from the first data store to the second data store according to the network protocol, using the packet-forwarding information; transferring student results information from the second data store to the first data stores, according to the network protocol; forming a set of progress indicators that reflect current student progress, using the student results information from the first data store and a set of predetermined inference rules; and generating at least one dashboard showing the set of progress indicators.

These and other aspects, features, and advantages of the present invention will become apparent from the following detailed description of preferred embodiments, which is to be read in connection with the accompanying drawings.

### BRIEF DESCRIPTION OF THE DRAWINGS

FIG. 1 shows an overall schematic illustration, of virtual secondary education system, according to a preferred embodiment of the present invention;

FIG. 2 shows an exemplary process for monitoring student progress in online courses and creating updated dashboards with information regarding student progress, interactions, and current escalation levels;

FIG. 3 shows an exemplary dashboard listing students in a particular class and their current progress in the course;

FIG. 4 shows an exemplary drill-down of the dashboard of FIG. 3 for a particular underperforming student;

FIG. 5 shows the dashboard of FIG. 3 filtered for underperforming students in the course;

FIG. 6 shows the dashboard of FIG. 3 filtered for escalation levels of ‘2’; and

FIG. 7 shows a dashboard listing recorded interactions with a particular student.

### DETAILED DESCRIPTION OF INVENTION

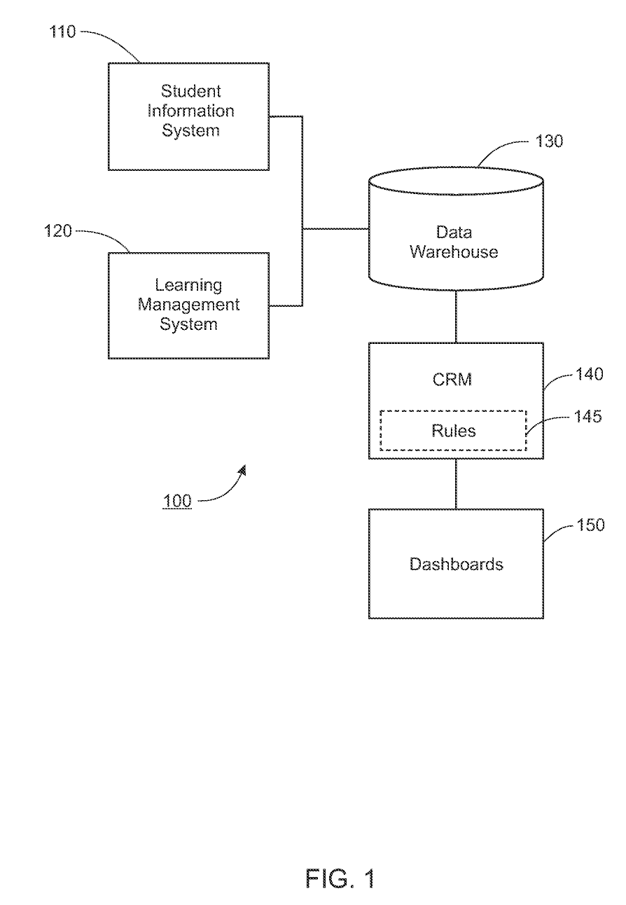

FIG. 1 shows an overall schematic illustration of a virtual secondary education system 100, according to a preferred embodiment of the present invention. As depicted in FIG. 1, the virtual secondary education system 100 includes a student information system (SIS) 110, a learning management system (LMS) 120, a data warehouse 130, and a customer relationship management (CRM) system 140. The SIS 110 and the LMS 120 store information in the data warehouse 130 used by the CRM 140 to produce various dashboards 150. As will be explained in greater detail, in producing the dashboards 150, the CRM 140 applies predetermined rules 145. The dashboards 150 are useful for assessing and monitoring student progress, and communicating student progress to instructors, administrators, and parents.

The SIS 110 includes capabilities for entering student test and other assessment scores, building student schedules, tracking student attendance, and managing many other student-related data needs of the virtual secondary education system 100. The SIS 110 can be configured to provide capabilities for student registration, attendance, medical records, grade reports, scheduling, tests and evaluation, academic history, transcripts, standardized tests reporting, etc. Additionally, the SIS 110 can be configured to allow uploading of student performance data to governmental entities/accreditation entities, for compliance purposes. Representative student information software that may be used to implement the SIS 110 include the GENESIS STUDENT INFORMATION SYSTEM, by Genesis Education Software, Jamesberg, N.J.

The LMS 120 includes capabilities for creating a virtual learning environment for online learning. In particular, the LMS 120 provides various online teaching and learning tools for delivery and management of courses, course content and learning outcomes. Preferably, the LMS 120 provides course information to enrolled students via the Internet (utilizing the TCP/IP network protocol). Students receive this course information on their student devices (preferably, a computer with a Web browser) and transmit back course results (such as homework assignments, online tests, etc.). Representative learning management software that may be used to implement the LMS 120 includes the ANGEL LEARNING MANAGEMENT SUITE, by Angel Learning, Inc., Indianapolis, Ind.

The data warehouse 130 can include any computer data storage system, but, preferably, is a relational database organized into logically-related records. In general, the data warehouse 130 is a collection of student/course/instructor information from all sources within the organization that is organized so that it can easily be accessed, managed, and updated. As mentioned, the SIS 110 and the LMS 120 store information in the data warehouse 130. Preferably, the data warehouse 130 includes a Database Management System (DBMS) useful for management of the data stored within the data warehouse 130. Representative DBMS that may be used by the present invention include Oracle Database by Oracle Corp., DB2 by IBM, and the SQL Server by Microsoft. The data warehouse 130 can either be a centralized or a distributed database.

The CRM 140 is a customer relationship management system adapted to apply a set of predetermined rules 145 for assessing student progress in online courses and output progress information to instructors to ensure that issues are resolved with students in a timely fashion. In general, various “off the shelf” customer management systems may be used and tailored to the present invention or this component can be programmed entirely from scratch. Representative customer relationship management systems that may be used include TALISMA, by Campus Management Corp., Baca Raton, Fla.

The SIS 110, the LMS 120, the data warehouse 130, and the CRM 140 are computer systems that include hardware and software components. Typical hardware requirements for the SIS 110, LMS 120, the data warehouse 130, and the CRM 140 include at least one server with at least an INTEL PENTIUM III processor; at least 1 GB RAM; 50 MB available disc space; and a suitable operating system installed, such as LINUX, or WINDOWS 2000, XP, or Vista by Microsoft Corporation. Representative hardware that may be used in conjunction with the software of the present invention includes the POWER EDGE line of servers by Dell, Inc. and the SYSTEM X enterprise servers by IBM, Inc. Other components of the present invention preferably include network interface elements. Such network interface elements can include any combination of wide area networks, local area networks, public switched telephone networks, wireless or wired networks, intranets, the Internet or any other distributed processing network or system. In general, the network infrastructure can be any known or later developed combination of systems, computer programs or structures useable to transmit and receive information among the SIS 110, the LMS 120, the data warehouse 130, and the CRM 140.

Although the SIS 110, the LMS 120, the data warehouse 130, and the CRM 140 are depicted as separate components (computer systems), it is to be appreciated that any (or all) of these may be implemented on a single server. For example, the SIS1 110 and the LMS 120 could be implemented as one computer system that incorporates functionality of both a student information system and a learning management system. Alternatively, any (or all) of the components may be implemented each on more than one physical server (e.g., using a “server farm”). Furthermore, it is to be appreciated that certain of the processing could be done remotely and/or in a virtual manner, such as, for example, by employing “cloud computing” techniques. It is to be appreciated that the virtual secondary education system 100, shown in FIG. 1, is meant to be illustrative, not limiting.

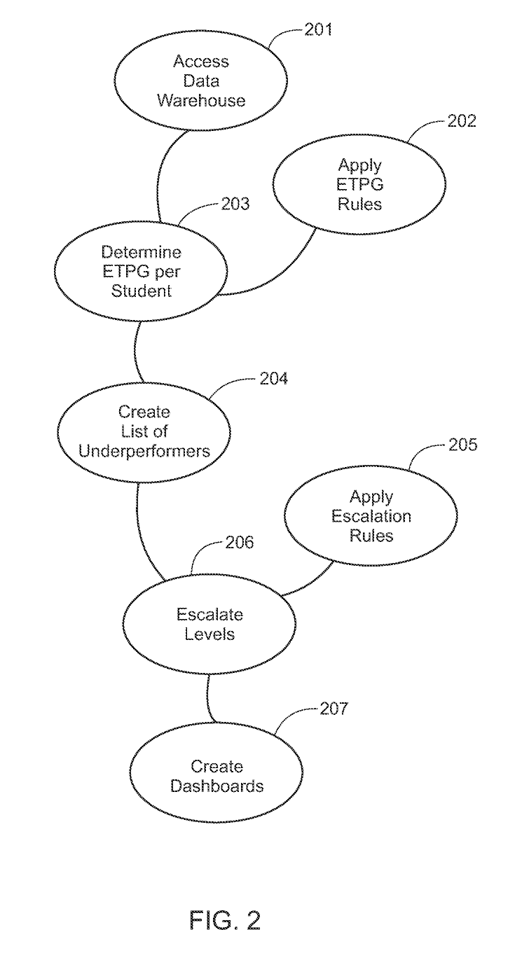

FIG. 2 depicts an exemplary process for monitoring student progress in online courses and creating updated dashboards with information regarding student progress, interactions, and escalation levels.

In process “Access Data Warehouse” 201, the CRM 140 queries the data warehouse 130 for information needed to determine certain factors associated with student achievement in online courses. In particular, four factors, namely, Engagement, Time, Pace, and Grade (collectively, “ETPG”), have been identified. “Engagement” refers to the student being committed enough to log into the system at sufficient intervals. “Time” refers to the amount of time that the student has put into the course. “Pace” refers to how much course material the student has completed relative to the number of weeks completed. “Grade” refers to the current student grade in the course.

A notable feature of the present invention is that it allows different students to be at different points in the course (e.g., completed different learning modules). This is not the case in the traditional bricks and mortar school or in most online environments. Although this presents challenges to the instructor, the present system can manage this situation well, particularly using the approach described herein, which involves systematically monitoring the student using factors which have been isolated and shown to be effective predictors of student course achievement.

To determine the ETPG factors and create the dashboards 150, the process “Access Data Warehouse” 201 obtains student records, course records, instructor records, interaction histories, and other necessary data. Preferably, this will be a batch process executed late at night (e.g., after 11 pm) or early (e.g., at 5 am) each day. Because some students and instructors log on at night, an established cut-off time is recommended. Alternatively, the process “Access Data Warehouse” 201 can be implemented as a real-time process that is executed to obtain the latest data any time the data warehouse 130 is updated.

Preferably, for the “Engagement” factor, the process “Access Data Warehouse” 201 can obtain the “last logged in” date/time for each course the student is enrolled in. The amount of time spent on a course used to determine the “Time” factor can be can be determined from the student's “log in” and “log out” times. The “Pace” factor requires obtaining information as to the latest learning module completed by the student. The “Grade” factor can be obtained by querying for the student's current course grade. Other information, such as student name and address (demographic data), instructor name, course name, and interaction histories will also be obtained.

An important feature of the present invention is that the data warehouse 130 stores all interactions with each student. Thus, when an instructor calls or emails the student or the student calls or emails an instructor, the date and time of the interaction and text describing the conversation is recorded and stored in the data warehouse 130. Such interaction history information can be indexed, and thereby sorted, for example, in chronological order. It can be made accessible from the data warehouse 130 to anyone in the organization needing this information. Such an arrangement allows a “call center” model in which any qualified individual can take a call from a student even if he or she is not the assigned instructor, using the interaction information obtained from the data warehouse 130, for guidance.

Next, in process “Apply ETPG Rules” 202, the CRM 140 applies predetermined rules 145 using the data obtained in the previous step to determine, in the process “Determine ETPG per Student” 203, the ETPG for each student in each course. For example, one rule might specify that a student who has logged in within the last 72 hours is said to be sufficiently “engaged”. Another rule could be that a student is expected to put in at least 20-30 hours each week per week for all courses together, assuming a four-course workload. The exact amount of time will depend on the number of courses taken and “offline” work (such as writing assignments). The rules for “Pace” could, for example, measure the student's module completion relative to the rest of the class or specify a benchmark for all students. In general, the rules 145 should be flexible enough to fairly assess the student's situation but also be measurable.

In process “Create List of Underperformers” 204, once the ETPG factors are determined for each student, the CRM 140 analyzes the student course information for the relevant ETPG, and creates a “score” in each of these ETPG categories for each course. As an example, a score of “1” can indicate an 80-100% compliance with the pertinent requirement; a score of “2” can indicate a 60-79% compliance with the pertinent requirement; and a score of “4” can indicate less than 60% compliance. Additionally, the CRM 140 can flag any student who received a “4” in any ETPG category for any course as an “underperforming student”. Thus, for example, if the student is taking four courses, the student must receive either a “1” or “2” in each of the four ETPG categories for each course.

In process “Apply Escalation Rules” 205, a set of rules 145 for determining the escalation level of a underperforming student are applied, and process “Escalate Levels” 206 sets the current escalation levels based on the applied rules 145. In general, once a student receives a “4”, the Escalation Level is set to Level 1 and the situation must be resolved within one week. If the issue is not resolved within one week, the escalation level is increased to Level 2, and so on. An important aspect of escalation is that it alerts others, such as management, to get involved.

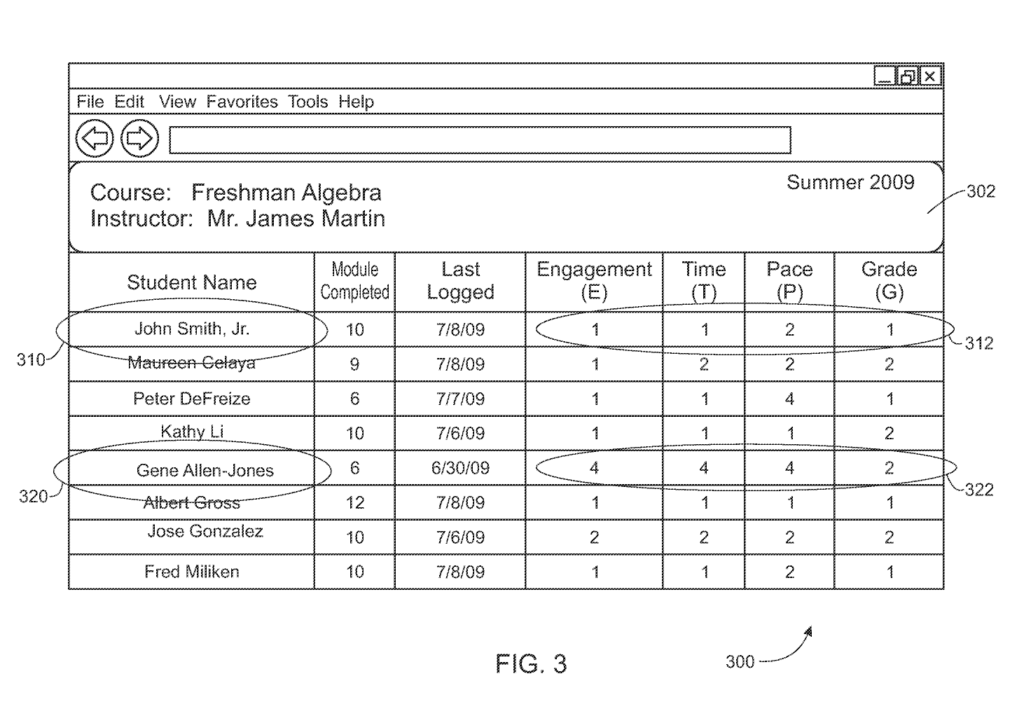

FIG. 3 shows an exemplary dashboard 300 listing students in a particular class and their current progress in the course. As depicted in FIG. 3, the exemplary dashboard 300 includes a course window 302 that includes course information, such as, for example, information identifying the course (e.g., “Freshman Algebra”), instructor (e.g., “Mr. James Martin”), and semester (e.g., “Summer 2009”). Preferably, the dashboard 300 will also include the respective ETPG factors for each student. For example, the dashboard 300 shows that student “John Smith, Jr.” 310 has the following ETPG scores 311: a “1” for Engagement; a “1” for Time, a “2” for Pace, and a “1” for Grade. In reading this formation, the instructor will understand that this student is on track. In contrast, the student “Gene Allen-Jones” 320 has the following ETPG scores 321: a “4” for Engagement; a “4” for Time, a “4” for Pace, and a “2” for Grade. These factors indicate to the instructor that this student needs immediate assistance.

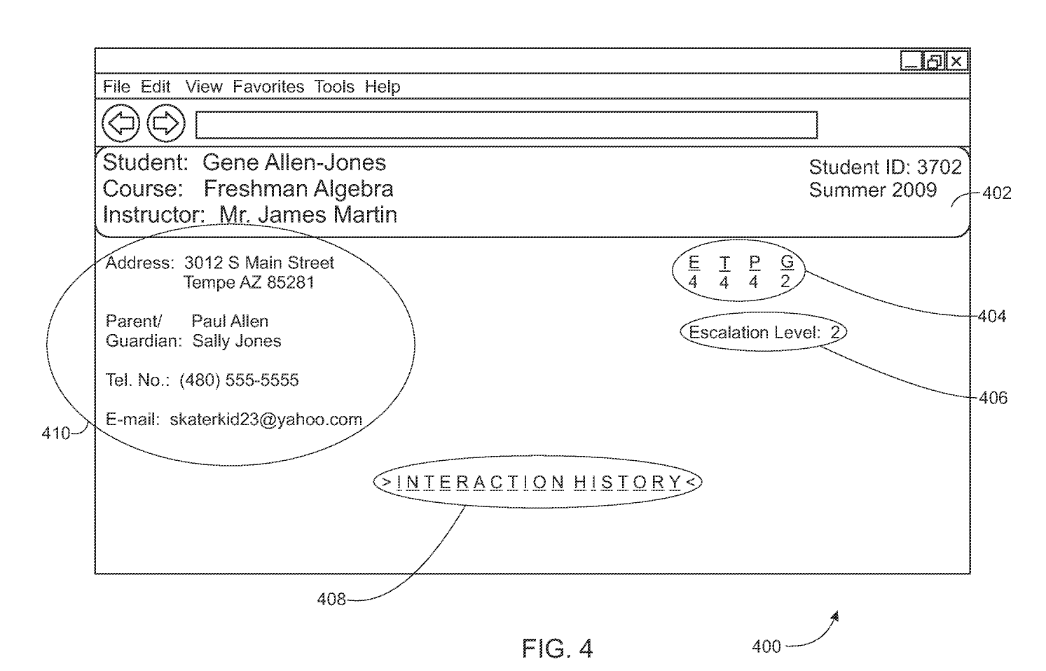

FIG. 4 shows an exemplary drill-down of the dashboard of FIG. 3 for a particular underperforming student (e.g., “Gene Allen-Jones” 320). As depicted in FIG. 4, course window 402 provides the student name (“e.g., “Gene Allen-Jones”), course name (“e.g., “Freshman Algebra”), instructor (e.g., “Mr. James Martin”), student ID (e.g., “3702”), and semester (e.g., Summer 2009”). Student demographic information window 410 displays, for example, the student's address, parents/guardian name(s), telephone number(s), and E-mail address. ETPG window 404 can be used to list the ETPG factors for the student. Escalation level window 406 can display the current escalation level for this student. Finally, an interaction history link 408 to the student's interaction history can be provided.

A notable feature of the present invention is to provide instructors with information each morning regarding progress of each student. Because ETPG information is made available via dashboard, others as well may use this information to advantage the student. For example, an instructor may relay to a parent that the student has not put enough time in the course, and armed with data from the dashboard, can explain the situation more clearly.

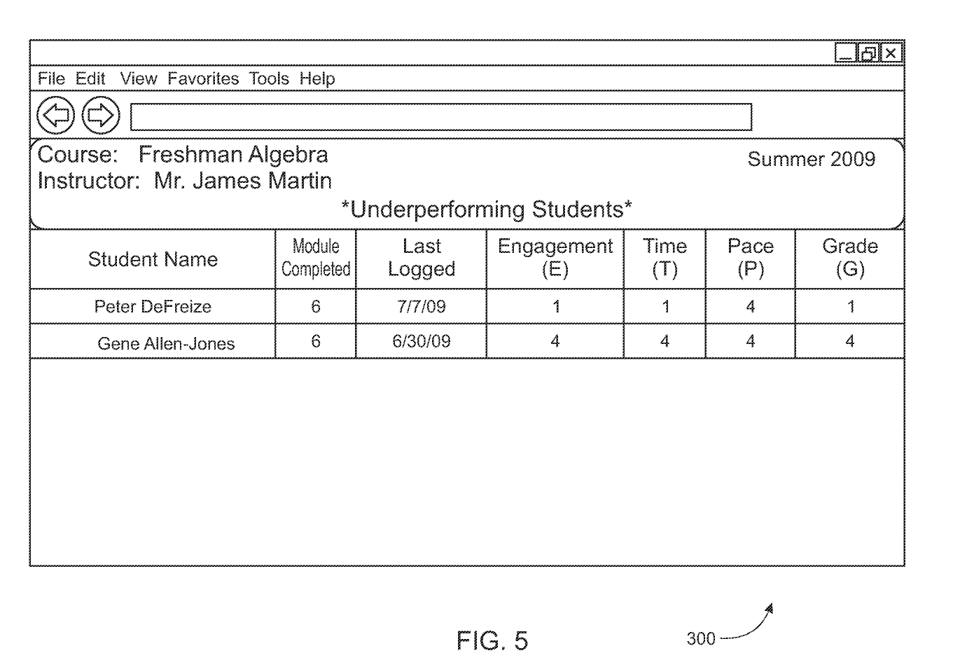

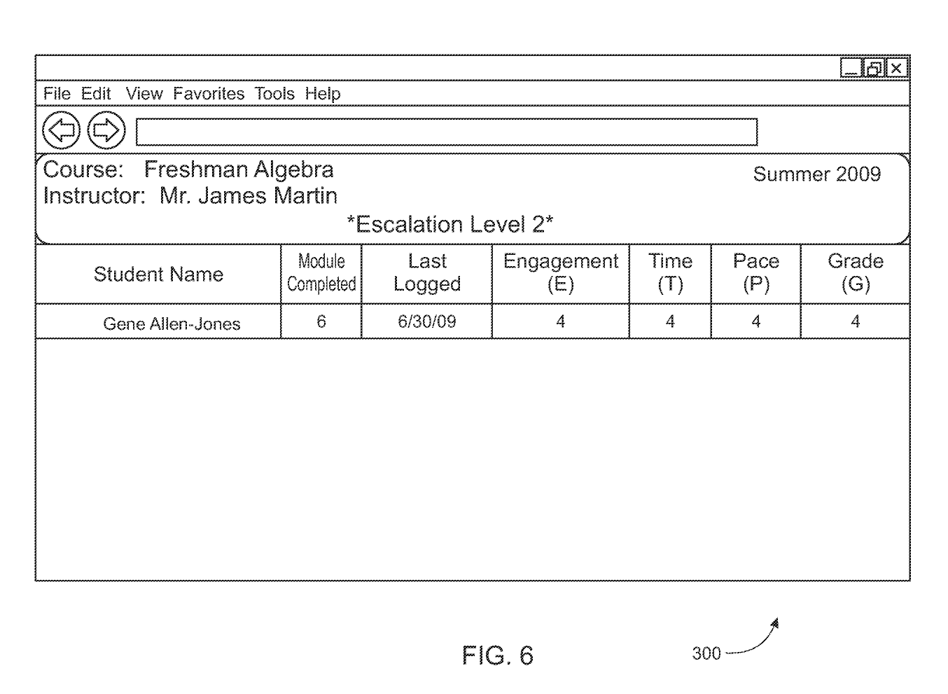

Additionally, the dashboards can have various filters and search functionality. An instructor can find basic information about a student (e.g., name, address, contact information, etc.) by clicking on a particular student from a list of students in the course. Referring to FIG. 5, the instructor would also be able to filter the list so that it only displays those students who have a particular ETPG factor (e.g., a “4” in a particular ETPG category). Referring to FIG. 6, the instructor might also filter escalation level (e.g., only list students with “Level 2” escalations).

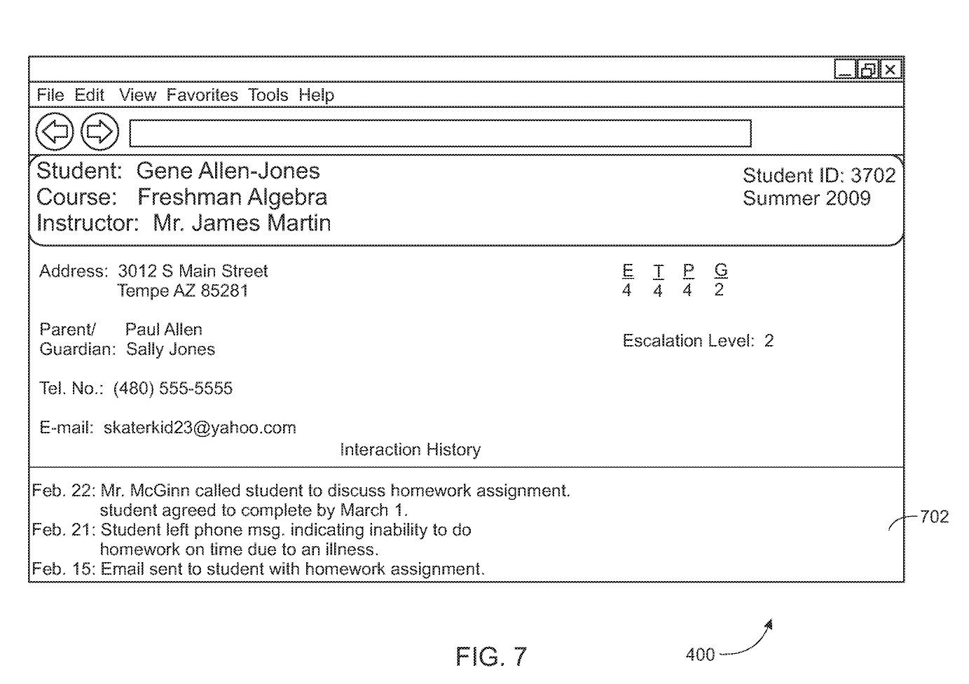

Also, the instructor might wish to consult the interaction history for a student to find when the last time a student was contacted and, perhaps, what the student agreed to do within a certain time frame. FIG. 7 shows an exemplary screen for listing an interaction history for a particular student. As shown in interaction history window 702, a list of interactions between the student and various other persons (including the instructor) is listed in chronological order. Preferably, the interaction history window 702 is a page-able window, thus allowing the user to page down or up for additional interaction information.

A notable feature of the present invention is that in addition to the dashboards, various other information can be obtained/mined from the data warehouse 130 which acts as a central repository. Additionally, since the present invention uses measurable, objective factors to predict outcomes, the rules 145 are susceptible to modification as actual outcomes are compared against predictions. Thus, although the present disclosure describes four pertinent progress indicators, other factors may be applied to measure student progress. The ability to mine information along with use of reliable progress indicators provides a novel tool for educators to maximize student achievement and success. Additionally, instructor performance can be more easily assessed.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A computer-implemented method for assessing student progress in an online secondary education environment, comprising:
obtaining, by a computer process, a result set from a database management system with information relating to student activity in an online secondary education course;
using the obtained result set and a set of predetermined rules to form, by the computer process, a set of progress indicators that reflect current student progress in the online secondary education course; and
generating, by the computer process, at least one dashboard showing the set of progress indicators.

2. The computer-implemented method of claim 1, wherein the set of progress indicators includes progress indicators relating to Engagement, Time, Pace, and Grade.

3. The computer-implemented method of claim 2, wherein the Engagement progress indicator relates to a measure of log-ins relative to a predetermined measure.

4. The computer-implemented method of claim 2, wherein the Time progress indicator relates to a measure of an amount of time put into a course relative to a predetermined measure.

5. The computer-implemented method of claim 2, wherein the Pace progress indicator relates to a measure of an amount of course material covered within a specified period relative to a predetermined measure.

6. The computer-implemented method of claim 2, wherein the Grade progress indicator relates to a measure of a course grade.

7. The computer-implemented method of claim 1, wherein the set of progress indicators includes progress indicators relating to Time, Pace, and Grade.

8. The computer-implemented method of claim 1, wherein the set of progress indicators includes progress indicators relating to any two of: Engagement, Time, Pace, and Grade.

9. The computer-implemented method of claim 1, wherein the set of predetermined inference rules include three or more of:
a predetermined rule for determining an Engagement indicator;
a predetermined rule for determining a Time indicator;
a predetermined rule for determining a Pace indicator; and
a predetermined rule for determining a Grade indicator.

10. The computer-implemented method of claim 1, wherein each progress indicator in the set of progress indicators is a scored value.

11. The computer-implemented method of claim 10, wherein the scored values are numerical.

12. The computer-implemented method of claim 10, wherein the scored values denote an adherence level of a predetermined compliance requirement.

13. The computer-implemented method of claim 10, wherein the scored values are determined according to each of the predetermined rules.

14. The computer-implemented method of claim 1, wherein the information relating to the student activity in the online course includes student records, course records, instructor records, and interaction histories.

15. The computer-implemented method of claim 1, wherein computer process is a batch computer process.

16. The computer-implemented method of claim 15, wherein the batch computer process is scheduled after a predetermined cut-off time.

17. The computer-implemented method of claim 1, wherein at least one of the generated dashboards includes a list of underperforming students.

18. The computer-implemented method of claim 17, wherein the list of underperforming students includes an escalation level for each of the students on the list.

19. The computer-implemented method of claim 18, wherein the escalation level relates to a length of time the student has been underperforming.

20. The computer-implemented method of claim 1, wherein at least one of the generated dashboards is a provided as a screen to an instructor.

21. The computer-implemented method of claim 1, wherein at least one of the generated dashboards is provided via a hyperlink.

22. The computer-implemented method of claim 21, wherein the hyperlink is included in an email note.

23. The computer-implemented method of claim 1, wherein at least one of the generated dashboards is provided to an administrator.

24. The computer-implemented method of claim 1, wherein at least one of the generated dashboards includes an interaction history with a student.

25. A computer-readable medium which stores a set of instructions which when executed performs a method for assessing student progress in an online secondary education environment, comprising: obtaining, by a computer process, a result set from a database management system with information relating to student activity in an online secondary education course; using the obtained result set and a set of predetermined inference rules to form, by the computer process, a set of progress indicators that reflect current student progress in the online secondary education course; and generating, by the computer process, at least one dashboard showing the set of progress indicators.

26. The computer-readable medium of claim 25, wherein the set of progress indicators includes progress indicators relating to Engagement, Time, Pace, and Grade.

27. The computer-readable medium of claim 26, wherein the Engagement progress indicator relates to a measure of log-ins relative to a predetermined measure.

28. The computer-implemented method of claim 26, wherein the Time progress indicator relates to a measure of an amount of time put into a course relative to a predetermined measure.

29. The computer-readable medium of claim 26, wherein the Pace progress indicator relates to a measure of an amount of course material covered within a specified period relative to a predetermined measure.

30. The computer-readable medium of claim 26, wherein the Grade progress indicator relates to a measure of a course grade.

31. The computer-readable medium of claim 25, wherein the set of progress indicators includes progress indicators relating to Time, Pace, and Grade.

32. The computer-readable medium of claim 25, wherein the set of progress indicators includes progress indicators relating to any two of: Engagement, Time, Pace, and Grade.

33. A system, comprising:
a Student Information System (SIS);
a Learning Management System (LMS);
a Data Warehouse that stores data from the SIS and the LMS; and
a system for assessing student progress, including:
an engine that obtains, by a computer process, a result set from the Data Warehouse with information relating to student activity in an online secondary education course, and uses the obtained result set and a set of predetermined rules, to form, by the computer process, a set of progress indicators that reflect current student progress in the online secondary education course; and
an output device capable of outputting at least one dashboard showing the set of progress indicators.

34. A method, comprising:
maintaining packet-forwarding information for communicating by a network protocol between a first data store and a second data store, the first data store including course information;
transferring the course information from the first data store to the second data store according to the network protocol, using the packet-forwarding information;
transferring student results information from the second data store to the first data stores, according to the network protocol;
forming a set of progress indicators that reflect current student progress, using the student results information from the first data store and a set of predetermined inference rules; and
generating at least one dashboard showing the set of progress indicators.

35. The method of claim 34, wherein the first data store is a database and the second data store is storage associated with a student device.

36. The method of claim 34, wherein the network protocol is TCP/IP.

37. The method of claim 34, wherein the set of progress indicators includes progress indicators relating to any two of: Engagement, Time, Pace, and Grade.

38. The method of claim 34, wherein the set of progress indicators includes progress indicators relating to any three of: Engagement, Time, Pace, and Grade.
